(19) United States
(12) Patent Application Publication
(10) Pub. No.: US 2013/0116912 A1
(43) Pub. Date: May 9, 2013

(54) FUEL INJECTOR CONTROL ADAPTATION METHOD

(71) Applicant: DAIMLER AG, Stuttgart (DE)

(72) Inventor: Frank Altenschmidt, Esslingen (DE)

(73) Assignee: DAIMLER AG, Stuttgart (DE)

(21) Appl. No.: 13/716,164

(22) Filed: Dec. 16, 2012

Related U.S. Application Data
(63) Continuation-in-part of application No. PCT/EP2011/002882, filed on Jun. 11, 2011.

(30) Foreign Application Priority Data
Jul. 15, 2010 (DE) 10 2010 027 267.1

(51) Int. Cl. G06F 19/00; B60T 7/12; G06F 17/00

(52) U.S. Cl. 701/103

(57) ABSTRACT

In a method for adapting an electric control of a fuel injector with a nozzle needle, with which fuel is metered for injection into a combustion chamber of an internal combustion engine, wherein a momentary operating state of the internal combustion engine is monitored and the electric control is adapted in dependence thereon, the momentary operating state is monitored based on a pressure prevailing in the respective combustion chamber, wherein an actual work value of a cylinder is determined based on the measured pressure, the determined actual work value is compared with a target work value assigned to the momentary operating state, and the adaptation of the electric control of the respective fuel injector is carried out dependent on the target-actual comparison of the momentary work of the respective combustion chamber and the lift of the nozzle needle of the fuel injector is corrected dependent on the target—actual comparison.

This is a Continuation-In-Part application of pending international patent application PCT/EP2011/002882 filed Jun. 11, 2011 and claiming the priority of German patent application 10 2010 027 267.1 filed Jul. 15, 2010.

### BACKGROUND OF THE INVENTION

The present invention relates to a method for adapting an electric control of a fuel injector via which fuel is metered into a combination chamber of an internal combustion engine.

DE 10 2006 07 823 A1 discloses a method for adapting an electric control of a fuel injector, in which a fuel injector comprises a nozzle needle with direct drive and serves for metering fuel injected into a combustion chamber of an internal combustion engine. In known adaptation methods, the momentary operating state of the international combustion engine is monitored and, in dependence hereon, the electric control, by which the fuel injector is operated, is adapted. Specifically, this is achieved in the known method in that the control energy and the needle lift of the fuel injection valve are controlled in such a way that the engine torque with a fuel injection valve having reference characteristics would not change. Herein an actually occurring change in the engine torque is detected and, by changing the increase in the control energy—needle-lift characteristic curve of the fuel injection valve, the engine torque is adapted to the engine torque generated with an injection valve with reference characteristics. The known method is used in particular to compensate for manufacturing-related or ageing-related changes in the injection behavior of the respective fuel injection valve.

It is the object of the present invention to provide an improved adaptation method which is characterized by high reliability.

### SUMMARY OF THE INVENTION

In a method for adapting an electric control of a fuel injector with a nozzle needle, with which fuel is metered for injection into a combustion chamber of an internal combustion engine, wherein a momentary operating state of the internal combustion engine is monitored and the electric control is adapted in dependence thereon, the momentary operating state is monitored based on a pressure prevailing in the respective combustion chamber, wherein an actual work value of a cylinder is determined based on the measured pressure, the determined actual work lo value is compared with a target work value assigned to the momentary operating state, and the adaptation of the electric control of the respective fuel injector is carried out dependent on the target-actual comparison of the momentary work of the respective combustion chamber and the lift of the nozzle needle of the fuel injector is corrected dependent on the target actual comparison.

The invention is based upon the general concept of monitoring the momentary operating state of an internal combustion engine based on of a pressure prevailing in the respective combustion chamber. For example a pressure sensor can be provided for this purpose for each combustion chamber, which pressure sensor is arranged at a suitable position on or in the combustion chamber. The pressure prevailing in the combustion chamber or the time-based pressure pattern in the combustion chamber correlates with the work actually generated in the respective cylinder and transferred to the respective piston.

In the adaptation method according to the invention, in dependence upon the measured pressure, an actual work value is determined which is compared with a target work value which can be assigned to the momentary engine operating state. This target work is thereby the work which should actually be realized with the current operating state on the basis of the control of the respective fuel injector and which is predefined for example by an engine control unit. In other words, the momentary operating state of the internal combustion engine is deter mined by an associated engine control unit, for example in order to be able to meet a certain power demand of the vehicle driver or a speed control unit of the vehicle. In dependence upon this desired target operating state, the engine control unit or an injector control unit coupled thereto activates the fuel injectors in order to bring about the desired target operating state via the fuel injection. The engine control unit thereby simultaneously also controls further components of the internal combustion engine or activates them, such as for example in case of a charged internal combustion engine, a variable turbine geometry, a throttle valve, variable valve drives and other flaps and valves, in particular for combustion air control, and possibly ignition units which may be present. The actual operating state which effectively is established is monitored with the method according to the invention using the pressure which is generated in the combustion chambers. This can take place for example in a cylinder-selective manner, that is to say, the pressure is individually detected for each cylinder or for each combustion chamber.

Depending upon the actual-target comparison of the momentary work of the respective combustion chamber, the electric control of the respective fuel injector can be adapted. If for example the actual work is too great, this points to too much fuel having been injected. For example a characteristic curve for activating the fuel injector, which represents the correlation between injected fuel quantity, needle lift and electric control signal, is correspondingly changed. Accordingly, with the correction of the needle lift, the amount of fuel to be injected can be adapted to the target operating state of the internal combustion engine.

The adaptation method is preferably a pure adaptation and not a regulation. While a regulation represents a regulating intervention whenever a deviation from a target value occurs, in the present case for each work cycle, in particular for each cylinder, an adaptation intervention adapts the electric control system only in dependence upon further secondary conditions, for example in order to introduce the respective adaptation with a permanent character that is a change in the control system. For example it can be provided that an adaptation of the electric control only takes place when the deviation from the target value exceeds a predetermined minimum during a predetermined number of successive work cycles. Staggered allocations of deviation values and repetition figures can thereby be considered so that a virtual weighting of the deviations is produced. For example, larger deviations must be repeated less often than smaller deviations in order to trigger a corresponding adaptation intervention.

The aim of the adaptation is thus not to compensate possibly temporary defective injections but instead to compensate production-related, thus essentially tolerance-related, deviations as well as symptoms of ageing.

According to an advantageous embodiment an actual pressure pattern for the respective combustion chamber can be measured, that is the development of the pressure over the crankshaft angle. It is possible to determine from this measured actual pressure pattern an indicated actual average pressure for the respective combustion chamber. The indicated average pressure represents the work per work cycle relative to the cubic capacity, with which the actual work of the respective combustion chamber can be determined from the determined indicated actual average pressure.

Such a determination of the actual work allows an adaptation of the electric control of the respective fuel injector even in case of comparatively small, in particular repeatedly occurring, target-actual deviations. Such smaller deviations are of increased interest in modern internal combustion engines, in which for example multi-injections are carried out in each cycle. Within the scope of such a multi-injection, with the aid of individual injections spaced apart in time from each other, only a comparatively small injection amount is to be introduced. Target-actual deviations have a particularly significant effect within these individual injections.

Correspondingly, in accordance with an advantageous embodiment the adaptation is carried out during a multi-injection operation, wherein the fuel is supplied to the respective combustion chamber in each cycle by means of a plurality of separate injections. It is also conceivable to carry out the adaptation during a single injection operation, wherein the fuel is supplied by means of a single injection to the respective combustion chamber.

The proposed adaptation method is particularly useful for internal combustion engines with direct fuel injection, wherein the fuel is metered directly into the combustion chamber. In particular in case of direct fuel injection with a stratified mixture, a stratification of the charge in the combustion chamber is achieved in that an ignitable mixture is present in the region of the ignition unit at the time of ignition, while in the more remote region of the ignition unit a leaner mixture is present. For example, in case of fuel injection based combustion methods, the fuel is injected into the combustion chamber and so orientated that at least part of the combustion air flow into which the fuel is injected in the combustion chamber moves in the direction of the ignition unit. Furthermore, wall-guided combustion methods are realized, in which wall areas, in particular on the piston, guide the fuel movement. In addition air-guided combustion methods are known, in which the fuel movement in the combustion chamber is guided extensively by the charge movement of the combustion air in the combustion chamber. The adaptation method proposed here can preferably be used with injection beam combustion methods, since, in such a method, the precise spray control is important.

The adaptation method proposed here is further suitable for fuel injectors with outwardly opening nozzles. Alternatively the adaptation method can also be used in fuel injectors which work with central, axially directed injection nozzles.

The adaptation method proposed here is further useful in connection with Fuel injectors which have a piezo-actuators as direct drives for actuating the nozzle needles. There is hereby a direct proportionality between the control voltage and needle lift. In principle the adaptation method can also be used in fuel injectors, wherein the direct drive works with an electro magnet for driving the nozzle needle. Furthermore the adaptation method can also be used in fuel injectors with a hydraulic actuation for the control of the nozzle needle.

With the adaptation method proposed here, fuel injectors can be adapted with self-igniting or externally ignited internal combustion engines. The adaptation method is also suitable both for internal combustion engines which are operated with liquid fuels and also for internal combustion engines which are operated with gaseous fuels.

What is claimed is:

1. A method for adapting an electric control of a fuel injector, with which fuel is metered into a combustion chamber of an internal combustion engine, wherein a momentary operating state in the combustion chamber of the internal combustion engine is monitored and the electric control is adapted in dependence thereon, the method comprising the steps of:
monitoring the momentary operating state based on the pressure prevailing in the respective combustion chamber,
determining an actual work value in dependence upon the pressure measured,
comparing the determined actual work value with a target work value assigned to the momentary operating state of the respective combustion chamber,
adapting the electric control of the respective fuel injector in dependence upon the target-actual comparison of the momentary work of the respective combustion chamber, and
correcting a lift of a nozzle needle of the fuel injector in dependence upon the target-actual comparison.

2. The method according to claim 1, wherein
an actual pressure pattern is measured for a respective combustion chamber,
an indicated actual average pressure is determined from the measured actual pressure pattern, and
the actual work of the respective combustion chamber is determined from the determined indicated actual average pressure.

3. The method according to claim 1, wherein the adaptation is carried out during a multi-injection operation, wherein the fuel is fed to the respective combustion chamber by means of a plurality of separate injections.

4. The method according to claim 1, wherein the adaptation is carried out during a single-injection operation, wherein the fuel is fed to the respective combustion chamber by means of a single injection.

5. The method according to claim 1, wherein a lift of the nozzle needle is corrected in dependence upon the target-actual comparison.

6. Method according to 1, wherein a nozzle needle of the fuel injector is controlled by a direct drive means.
